(19) United States
(12) Patent Application Publication
(10) Pub. No.: US 2007/0291042 A1
(43) Pub. Date: Dec. 20, 2007

(54) DISPLAY SUBSTRATE HAVING INTEGRATED BYPASS CAPACITORS, DISPLAY DEVICE HAVING THE SAME AND METHOD OF MANUFACTURING THE SAME

(76) Inventors: Yun-Hee KWAK, Seoul (KR); Jong-Woong Chang, Chungcheongnam-do (KR); Seung-Hwan Moon, Gyeonggi-do (KR)

Correspondence Address: MACPHERSON KWOK CHEN & HEID LLP, 2033 GATEWAY PLACE, SUITE 400, SAN JOSE, CA, 95110, US

(21) Appl. No.: 11/763,122

(22) Filed: Jun. 14, 2007

(30) Foreign Application Priority Data
Jun. 19, 2006 (KR) 2006-54699

(51) Int. Cl. G06F 13/18

(52) U.S. Cl. 345/535

(57) ABSTRACT

A display substrate includes an output pads section, a fan-out section, a first power wiring section and a first conductive pattern. The output pads section is electrically connected to a plurality of output terminals of a first driver chip. The fan-out section electrically connects the output pads section to a plurality of source wirings. The first power wiring section is extended along a longitudinal direction of a plurality of gate wirings that cross with source wirings of the display substrate. The first power wiring section propagates at least first and second power-delivering voltages to the driver chip. The first conductive pattern is insulatively overlapped with the first power wiring section in an intermediate area between the output pads sections of an adjacent second driver chip. The first conductive pattern thereby defines a capacitive shunting path for voltage transients or ripples.

### CROSS-REFERENCE TO RELATED APPLICATIONS

This application claims priority under 35 U.S.C. §119 to Korean Patent Application No. 2006-54699 filed on Jun. 19, 2006 in the Korean Intellectual Property Office (KIPO), the disclosure of which is herein incorporated by reference.

### BACKGROUND

1. Field of Invention

The present disclosure of invention relates to on-glass or on-substrate integrated circuitry such as found in Liquid Crystal Display (LCD) devices and more particularly to a transparent display substrate comprising a means for enhancing reliable switching of a driving signal that is generated by an on-substrate circuit, and a display device having the reliability-enhanced display substrate.

2. Description of Related Art

Generally, a liquid crystal display (LCD) device includes a display panel that displays an image using light transmittance through a liquid crystal material and through a transparent substrate such as one made of glass, where the panel includes an array of switching elements for controlling electric fields applied to pixel areas of the LCD device and the panel further includes a gate driving circuit electrically connected to output one or more gate signals across a display area of the panel, and a source driving circuit electrically connected to output one or more data signals across the display area of the panel. The display panel may be viewed as including a plurality of pixel parts where each of the pixel parts includes a switching element and a liquid crystal capacitor electrically connected to the switching element. The gate driving circuit provides the switching element with a corresponding gate signal for turning on the switching element (switching it into a conductive state), and the source driving circuit provides the switching element with a corresponding digital or analog data signal for driving the liquid crystal capacitor to a desired state of charge (or discharge).

Typically, an output buffer is provided electrically in line with an output terminal of the source driving circuit where the latter encompassing circuit is disposed on a circuit board separate from the panel substrate. The conventional off-substrate output buffer has a transient bypass capacitor coupled to power terminals of the buffer for reducing or eliminating a power line transient or ripple component that can result from rapid switching of the data signal output by the output buffer. Generally, the off-substrate output buffer is disposed in the source driving circuit and the latter is mounted to a printed circuit board (PCB) separate from the panel substrate. The corresponding bypass capacitor is discretely mounted on the same PCB.

Recently, as LCD devices have become smaller in size and acquired additional advantageous attributes such as: a light weight, low manufacturing costs and high light efficiency; the industry has begun to adopt a chip-on-glass (COG) method. In the COG method, the source driving circuit is embodied in a monolithic integrated circuit (chip) that is directly mounted, fused or bonded to the glass substrate portion of (or other dielectric substrate portion of) the display panel. However, when the COG method is employed, formation of the bypass capacitor for stabilizing the output signal of the source driving circuit is not easy, especially if it is to be formed integrally on the same dielectric substrate adjacent to its corresponding output buffer. Consequently, those who have heretofore employed the COG method have shied away from having an adjacent bypass capacitor and the data signal output from the source driving circuit has had a tendency to be unstable due to insufficient damping of the ripple component by the missing bypass capacitor, and as a result, display quality has suffered when the COG method is adopted.

### SUMMARY

The present disclosure of invention provides a means for enhancing the switching reliability of panel driving data signals by integrating one or more bypass capacitors on the glass substrate portion of (or other dielectric substrate portion of) the display panel.

In one embodiment, a display substrate includes an output pads section, a fan-out section, a first power wiring section and a first conductive pattern that is capacitively coupled across the first power wiring section. The output pads section is electrically connected to a plurality of output terminals of a driver chip. The fan-out section electrically connects the output pads section to a plurality of source wirings. The first power wiring section is extended along a longitudinal direction of a plurality of gate wirings that cross the source wirings. The first power wiring section supplies power such as by propagating a first driving voltage and a ground voltage to the driver chip. The first conductive pattern is capacitively overlapped with the first power wiring section so as to define an integrated bypass capacitor that provides a shunting path between ground and the first driving voltage for locally generated AC spikes or transients. In one embodiment, the first conductive pattern is formed between driver chips, in an intermediate area between the output pads sections of adjacent driver chips.

In another embodiment, a display device includes a gate driving section, a plurality of source driver chips, a first voltage wiring section, a second voltage wiring section and a first conductive pattern. The gate driving section outputs a gate signal to a plurality of gate wirings of a display area. The source driver chips output a data signal to a plurality of source wirings that cross the gate wirings. The first voltage wiring section is formed in a peripheral area having the source driver chips mounted therein. The first voltage wiring applies a first driving voltage to the source driver chips. The second voltage wiring section is formed in the peripheral area. The second voltage wiring section applies second driving voltages to the source driving sections. The first conductive pattern is overlapped with the first voltage wiring section formed in an intermediate area between the driver chips adjacent to each other to stabilize the data signal.

In still another embodiment, according to a method of manufacturing one or more bypass capacitors integrally on a display substrate having a corresponding one or more power wiring sections disposed thereon for propagating power-delivering voltages to integrated circuits that are to be further mounted to the display substrate, a dielectric layer is disposed over at least a first of voltage propagating conductors extending in the one or more power wiring sections. Then, a conductive pattern is disposed on the dielectric layer so that the conductive pattern insulatively overlaps the at least first of voltage propagating conductors. The conductive pattern further overlaps at least a second of the voltage propagating conductors extending in the one or more power wiring sections so as to thereby define a capacitive shunt path for AC voltage signals appearing between the at least first and second of the voltage propagating conductors.

Accordingly, with a the display substrate and display device having such a display substrate, a ripple component of a data output signal may be easily removed in the display device, so that display quality of the display device may be enhanced.

### BRIEF DESCRIPTION OF THE DRAWINGS

The above and other advantages of the present disclosure of invention will become clearer by reference to the following detailed description when considered in conjunction with the accompanying drawings wherein:

FIG. 1 is a plan view illustrating a display device according to an exemplary embodiment;

FIG. 2 is an enlarged plan view illustrating a portion of the display substrate in FIG. 1;

FIG. 3 is a cross-sectional view taken along the line I-I′ in FIG. 2;

FIG. 4 is an equivalent circuit diagram illustrating a source driving circuit in FIG. 1;

FIG. 5 is a plan view illustrating a display device according to another exemplary embodiment;

FIG. 6 is an enlarged plan view illustrating a portion of a display substrate in FIG. 5;

FIG. 7 is a cross-sectional view taken along the line II-II′ in FIG. 6; and

FIG. 8 is an equivalent circuit diagram illustrating a source driving circuit in FIG. 5.

### DETAILED DESCRIPTION

It is to be understood that when an element or layer is referred to herein as being “on,” “connected to” or “coupled to” another element or layer, it can be either directly on, connected to or coupled to the other element or layer, or one or more intervening elements or layers may be present for providing indirect coupling. In contrast, when an element is referred to herein as being “directly on,” “directly connected to” or “directly coupled to” the other element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited in number by these terms. These terms are only used to distinguish one element, component, region, layer or section from another region, layer or section. Thus, a first element, component, region, layer or section discussed below could be instead termed a second element, component, region, layer or section.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the present disclosure of invention.

Embodiments described herein with reference to cross-section illustrations are to be considered as schematic illustrations of idealized embodiments (and intermediate structures). As such, variations from the shapes of the illustrations as a result, for example, of specific manufacturing techniques and/or tolerances, are to be expected. Thus, the disclosure should not be construed as being limited to the particular shapes of regions illustrated herein but is to be construed as including routine design choices and deviations in shapes that result, for example, from specific manufacturing techniques. For example, an implanted region that is schematically illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the disclosure.

Unless otherwise defined, all terms (including technical and scientific terms) used herein have the same ordinary meaning as commonly understood by one of ordinary skill in the art to which this disclosure most closely pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

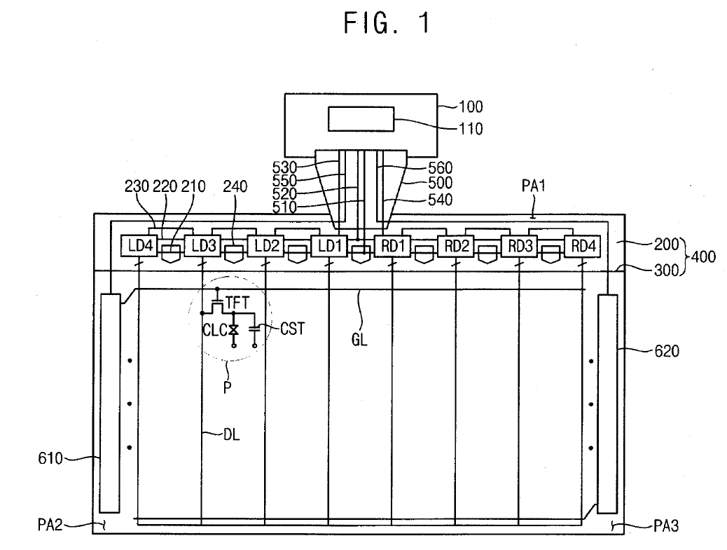

FIG. 1 is a plan view illustrating a display device according to an exemplary embodiment.

Referring to FIG. 1, a display device in accordance with the disclosure includes a first printed circuit board (PCB) 100, a display panel 400 and a flexible second PCB (also referred to as a FPC) 500.

A main driving circuit 110 is mounted on the PCB 100. The main driving circuit 110 receives original control signals and an original driving signals from an external device (not shown), and outputs corresponding control signals and driving signals for driving the display panel 400 via the flexible second PCB 500.

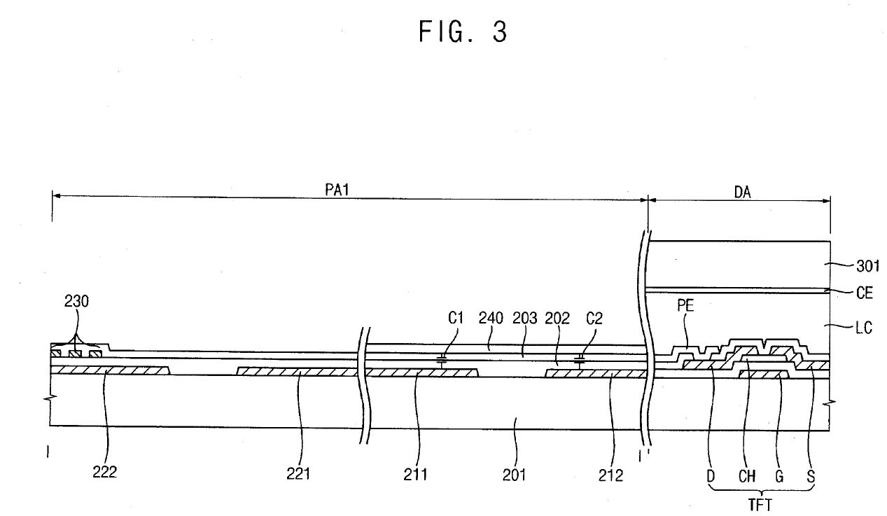

The display panel 400 includes a display substrate 200 and an opposite substrate 300 that is combined with the display substrate 200 to receive an interposed liquid crystal layer (not shown). Each of the two opposed substrates 200 and 300 includes a relatively transparent section for allowing light to pass therethrough. The display panel 400 includes a display area DA (see FIG. 3), a first peripheral area PA1 (top side in FIG. 1), a second peripheral area PA2 (left side) and a third peripheral area PA3 (right side). The middle display area DA is relatively transparent and is used to form an image for display to a user. The first, second and third peripheral areas PA1, PA2 and PA3 surround a corresponding three sides of the display area DA. Peripheral areas PA1, PA2 and PA3 are typically also transparent to some degree but do not have to be (i.e., they can have nontransparent driver circuits mounted in them).

A plurality of source lines (also referred to as data lines) DL and a plurality of gate lines GL are formed across the display area DA. The source lines (DL) and gate lines GL cross orthogonally with respect to each other. A plurality of pixel parts P are defined at respective crossings of the source lines DL and the gate lines GL. Each of the pixel parts P includes a switching element, such as a thin-film field effect transistor (TFT), a liquid crystal capacitor CLC (defined by a corresponding pixel-electrode, and opposed common electrode and interposed liquid crystal material) and a charge storage capacitor CST.

A plurality of source driver chips is bonded to the substrate of the display panel 400 in the first peripheral area PA1 thereof. The source driver chips apply data voltages to the source lines DL, respectively for propagation across the display area. More particularly, in the illustrated embodiment, a first plurality of left-side source driver chips LD1, LD2, LD3 and LD4 are mounted in a left portion of the first peripheral area PA1, and a second plurality of right-side source driver chips RD1, RD2, RD3 and RD4 are mounted in a right portion of the first peripheral area PA1.

A plurality of first power wiring sections (or first power buses) 210, a plurality of second power wiring sections (or second power buses) 220, a plurality of connection wiring sections (or signal buses) 230 and a plurality of conductive patterns 240 are formed in the first peripheral area PA1 and are electrically coupled to respectively adjacent ones of the source driver chips LD1, . . . , RD4. For example, the first power wiring section 210 transfers first driving voltages, such as a first power voltage VDD1 and a first ground voltage VSS1, to the source driver chip LD3 (i.e., to internal PMOS and NMOS buffering transistors within LD3). The second power wiring section 220 transfers second driving voltages, such as a second power voltage VDD2 and a second ground voltage VSS2, to the same source driving chip LD3 (i.e., to internal PMOS and NMOS transistors that define DAC's within LD3). The connection wiring section 230 transfers a data signal and one or more gamma-corrected level signals to the same source driver chip LD3. The data signal and gamma signal(s) are transferred between corresponding pairs of source driver chips such as LD2 and LD3 that are cascade connected with each other through the connection wiring section 230.

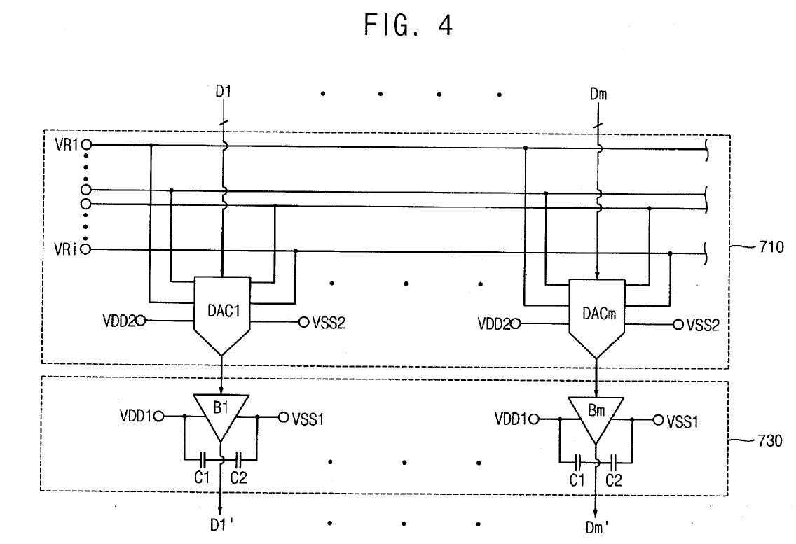

The conductive pattern 240 is insulatively overlapped with at least one of the conductors in the first power wiring section 210 and the conductive pattern 240 is further overlapped with at least a second of the conductors in the first power wiring section 210 so as to thereby define a transient bypass capacitor at least for voltages developed locally on the first and second conductors in the first power wiring section 210. Because the conductive pattern 240 forms a predetermined capacitance between a power line transferring the first power voltage VDD1 and a ground line transferring the first ground voltage VSS1 of wiring section 210, the bypass capacitor helps to maintain steady levels (i.e., ripple-free levels) for the first power voltage VDD1 and for the first ground voltage VSS1 in the vicinity of the adjacent source driver chips (i.e., LD2 and LD3). Therefore, a switching noise component of the data signal, which may be output from the corresponding source driver chip (i.e., LD3) and propagated along the first power wiring section 210, may be removed or decreased. (FIG. 4 shows a schematic of one embodiment in which the conductive pattern 240 defines the series connected combination of capacitors C1 and C2 so as to thereby reduce or remove switching noise voltage transients that may otherwise appear across power connection nodes V_{DD1} and V_{SS1}. FIG. 4 will be detailed below.) Referring still to FIG. 1, a plurality of gate driving sections 610 and 620 output respective gate signals to interdigitated gate lines such as the one labeled GL. The gate driving sections 610 and 620 are integrated or mounted in the second and third peripheral areas PR2 and PR3 of the substrate. Each of the gate driving sections 610 and 620 that are electrically connected to the gate lines alternatingly and sequentially outputs a gate signal to one of its gate lines so as to thereby provide for interlaced vertical raster scanning of the display area (DA). In the FIG. 1, the gate driving sections 610 and 620 are formed in the second and third peripheral areas PA1 and PA2, which form two spaced-apart portions of the display area DA, respectively. Alternatively, the gate-line driving sections 610 may have been formed only in the second peripheral area PA2 together with gate-line driving sections 620.

A plurality of power and signal wiring sections 510, 520, 530, 540, 550 and 560 are arranged in the FPC 500. The power and signal wiring sections 510, 520, 530, 540, 550 and 560 electrically interconnect the PCB 100 and the display panel 400. The wiring sections 510, 520, 530, 540, 550 and 560 transfer control signals and power signals that are provided from the main driving circuit 110 to the display panel 400.

For example, the first signal wiring section 510 transfers first driving voltages VDD1 and VSS1 to the first power wiring section 210. The second signal wiring section 520 transfers second power voltages VDD2 and VSS2 to the second power wiring section 220. Each of the first and second signal wiring sections 510 and 520 is electrically connected (distributed) to the corresponding ones of the first and second power wiring sections 210 and 220 that are arranged on the left and right sides of the panel. For example, lines 510 and 520 are shown to connect between the first source driver chip LD1 on the left side and a first source driver chip RD1 on the right side.

A third signal wiring section 530 includes a plurality of signal wirings that transfer the data signals and gamma signals that are provided to the source driver chips LD1, LD2, LD3 and LD4 that are mounted in a left portion of the first peripheral area PA1. The third signal wiring section 530 is electrically connected to the first source driver chip LD1 of the left portion. The data signals and the gamma signals that enter the middlemost, left source driver chip LD1 may be serially transferred to the other source driver chips LD2, LD3 and LD4 of a left portion by a signal cascading method.

A fourth signal wiring section 540 includes a plurality of signal wirings that transfer data signals and gamma signals that are provided to the source driver chips RD1, RD2, RD3 and RD4 that are mounted in a right portion of the first peripheral area PA1. The fourth signal wiring section 540 is electrically connected to the first source driver chip RD1 of the right portion. The data signals and the gamma signals that enter the middlemost, right source driver chip RD1 may be transferred to the other source driver chips RD2, RD3 and RD4 of the right portion by a signal cascading method.

A fifth signal wiring section 550 includes a plurality of signal wirings that transfer gate driving signals to the first gate driving section 610 formed in the second peripheral area PA2. A sixth signal wiring section 560 includes a plurality of signal wirings that transfer gate driving signals to the second gate driving section 620 formed in the third peripheral area PA3.

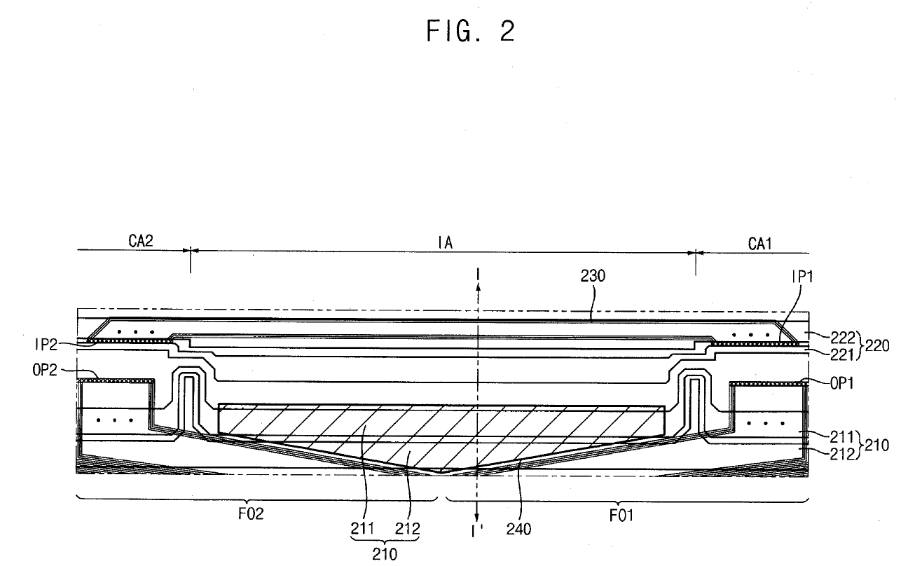

FIG. 2 is an enlarged plan view illustrating a portion of the display substrate in FIG. 1 that includes conductive pattern 240.

Referring to FIGS. 1 and 2, repeated sections in the first peripheral area PA1 may be each subdivided into three functional regions, namely, a first chip area CA1 having a first source driver chip (i.e., LD1) mounted therein by chip-to-glass (COG) or other bonding means, a second chip area CA2 having a second source driver chip (i.e., LD2) mounted therein by chip-to-glass or other bonding means and an intermediate area IA interposed between the first and second chip areas CA1 and CA2.

The first power wiring section 210 and the second power wiring section 220 are commonly formed to extend through the first chip area CA1, the intermediate area IA and the second chip area CA2. A signal connection wiring section 230 is formed in the intermediate area IA. The first power wiring section 210 includes a first voltage-supplying conductor 211 (V_{DD1}) and a first ground-supplying conductor 212 (V_{SS1}). For example, the first voltage-supplying conductor 211 may be structured to receive a first power voltage from an external source and to propagate the first power voltage to the at least one of the ICs. For example, the first ground-supplying conductor 212 may be structured to extend wiring that is substantially parallel to the first voltage-supplying conductor 211 and to receive a first ground voltage from an external source and to propagate the first power voltage to said at least one of the IC. The second power wiring section 220 includes a second voltage-supplying conductor 221 (V_{DD2}) and a second ground-supplying conductor 222 (V_{SS2}). The signal connection wiring section 230 includes a plurality of wirings for transferring corresponding data signals and gamma signals.

A first input pads section IP1 and a first output pads section OP1 are formed in the first chip area CA1. The first input pads section IP1 includes means (not shown) for contacting the first and second power wiring sections 210 and 220 for obtaining corresponding power and ground voltages (V_{DD1} and V_{SS1}) and for coupling these to appropriate power input terminals of the first source driver chip LD1. The first output pads section OP1 contacts output terminals of the first source driver chip LD1. A first fan-out section FO1 is formed in the first chip area CA1. The first fan-out section FO1 is electrically connected to the first output pads section OP1, and is insulatively overlapped with the first power wiring section 210.

A second input pads section IP2 and a second output pads section OP2 are formed in the second chip area CA2. The second input pads section IP2 contacts the first and second power wiring sections 210 and 220 and couples them to appropriate input terminals of the second source driver chip LD2. The second output pads section OP2 contacts corresponding output terminals of the second source driver chip LD2. A second fan-out section FO2 is formed in the second chip area CA2. The second fan-out section FO2 is electrically connected to the second output pads section OP2, and is insulatively overlapped with the first power wiring section 210.

The first and second power wiring sections 210 and 220, the connection wiring section 230 and the conductive pattern 240 are formed in the intermediate area IA. The connection wiring section 230 is formed in the intermediate area IA to insulatively overlap with a portion of the second power wiring section 220. The conductive pattern 240 is formed in the intermediate area IA so as to insulatively overlap with a portion of the first power wiring section 210. In one embodiment, the conductive pattern 240 has the shape of an irregular pentagon such as that formed by attaching the base of a triangle to the bottom side of a rectangle whose bottom dimension is the same as the base of the downwardly protruding triangle.

A first portion of the first power wiring section 210 is overlapped with the first and second fan-out sections FO1 and FO2, and a second portion of that section 210 is overlapped with the conductive pattern 240. That is, the conductive pattern 240 is formed in the intermediate area IA so as not to substantially overlap with the first and second fan-out sections FO1 and FO2 and thereby create parasitic capacitance coupling between the first and second fan-out sections FO1 and FO2.

The first power wiring section 210 includes a first voltage-supplying conductor 211 and a ground voltage wiring 212. In one embodiment, a capacitively-effective overlap area between the conductive pattern 240 and the first voltage-supplying conductor (V_{DD1}) 211 is greater than a capacitively-effective overlap area between the conductive pattern 240 and the first ground voltage wiring (V_{SS1}) 212.

A first capacitor C1 (see also FIG. 4) is defined by the insulative overlapping of the first voltage-supplying conductor 211 and the conductive pattern 240, and a second capacitor C2 is defined by the insulative overlapping of the first ground voltage wiring 212 and the conductive pattern 240. As a result, the capacitance of the first capacitor C1 is greater than that of the second capacitor C2 in the illustrated embodiment. And further as a result, a DC bias voltage that develops on the conductive pattern 240 is substantially closer to the VDD1 level than to the VSS1 level. A first power voltage VDD1 and a first ground voltage VSS1 that are propagated by way of the first power wiring section 210 may be stabilized (i.e., immunized at least partially against switching noise transients) by the noise-shunting series circuit formed by the first and second capacitors C1 and C2.

FIG. 3 is a cross-sectional view taken along the line I-I′ in FIG. 2.

Referring to FIGS. 1 to 3, in one embodiment, the display panel 400 includes a TFT-supporting substrate (200), an opposed, common electrode supporting substrate (300) and an interposed liquid crystal layer (LC).

A pixel part having a switching element such as a thin film transistor (TFT) and a liquid crystal capacitor CLC is formed in the display area DA. More particularly, a gate electrode G is formed from a first conductive layer deposited (bonded to) a transparent first base substrate 101 of the panel. A gate insulating layer 202 is formed on (i.e., deposited over) the first conductive layer that forms the gate electrode G. A semi-conductive channel layer (CH, i.e. doped polysilicon) is formed on the gate insulating layer 202 corresponding to the gate electrode G. A source electrode S and a drain electrode D are patterned out of a second conductive layer that is deposited on the semi-conductive channel layer CH to thereby define a thing film transistor whose conduction is controlled by the gate electrode G.

A source/drain passivation layer 203 is formed by deposition of dielectric material on the source and drain electrodes S and D. A pixel electrode PE is formed on the passivation layer 203 and extends through a via to contact the drain electrode D. The pixel electrode PE is typically composed of an optically transparent and electrically conductive material. The pixel electrode PE may define a first electrode of the liquid crystal capacitor CLC. A common electrode CE as a second electrode of the liquid crystal capacitor CLC is formed on a second base portion 301 of the opposing substrate 300. A liquid crystal layer LC is interposed between the pixel electrode PE and the common electrode CE.

The first conductive layer that forms the gate electrode (G) may be further patterned in the peripheral area (PA1) to define the first voltage-supplying conductor (Vdd1) 211, the first ground voltage wiring (Vss1) 212, the second voltage-supplying conductor (Vdd2) 221 and the second ground voltage wiring (Vss2) 222 as extending along a longitudinal direction parallel to the longitudinal direction of gate wirings GL formed in the first peripheral area PA1. For example, the first voltage-supplying conductor 211 and the first ground-supplying conductor 212 are formed spaced-apart but adjacent to each other. The first voltage-supplying conductor 211 extends substantially parallel to the first ground voltage wiring 212. The second voltage-supplying conductor 221 and the second ground voltage wiring 222 are also formed in spaced apart regions but adjacent to each other. The second voltage-supplying conductor 221 is substantially parallel to the second ground voltage wiring 222. The gate insulating layer 202 is formed on the first voltage-supplying conductor 211, on the first ground voltage wiring 212, on the second voltage-supplying conductor 221 and on the second ground voltage wiring 222.

The signal connection wiring section 230 is patterned out of a second conductive layer that is formed on the gate insulating layer 202 to partially overlap with the second ground voltage wiring section 222. The first fan-out section FO1 is also formed from the second conductive layer. The first fan-out section FO1 is formed in the first chip area CA1 to overlap with the first voltage-supplying conductor 211 and the first ground voltage wiring 212 as best seen in FIG. 2.

The passivation layer 203 of FIG. 3 is formed on the second conductive layer. The conductive pattern 240 is patterned out of a third conductive layer that is formed (i.e., deposited with an appropriate conductor deposition process) on the drain/source passivation layer 203. The conductive pattern 240 is formed in the intermediate area IA to overlap with the first voltage-supplying conductor 211 and the first ground voltage wiring 212 as best seen in FIG. 2.

As a result of the insulative overlap defined between the conductive pattern 240 and the power conduction strips 211-212, a first capacitor C1 is defined by the overlap of the first voltage-supplying conductor 211 with the conductive pattern 240, and a second capacitor C2 is defined by the overlap of the first ground voltage wiring 212 with the conductive pattern 240. Thus, the first capacitor C1 is serially connected to the second capacitor C2 between the first power wiring 211 and the first ground-supplying conductor 212, so that a transient-bypassing capacitance, C_{cap} is defined by the first and second capacitors C1 and C2 so as to be satisfied for example by the following Expression 1.

$$Ccap = \frac{1}{( \frac{1}{C 1} + \frac{1}{C2} )} \qquad Expression 1$$

FIG. 4 is an equivalent circuit diagram illustrating an embodiment of a source driving circuit as may be used in FIG. 1.

Referring to FIGS. 1 and 4, each of the source driver chips LD1, LD2, LD3, LD4, RD1, RD2, RD3 and RD4 may include a digital-to-analog converting section 710 and an output buffering section 730.

The digital-analog converting section 710 includes a plurality of digital-to-analog converters DAC1, DAC2, . . . , DACm-1 and DACm corresponding to respective output terminals of the source driver chip. Each of the digital-analog converters DAC1, DAC2, . . . , DACm-1 and DACm receives a second power voltage VDD2 and a second ground voltage VSS2 as second power-providing voltages, and for example, in the case of the digital-analog converter DAC1, each receives a corresponding multi-bit digital data signal D1 and a plurality of gamma-corrected voltage levels VR1, VR2, . . . , VRi-1 and VRi through the connection wiring section 230. The digital-analog converter DAC1 outputs a selected one of the gamma-corrected voltages VR1, VR2, . . . , VRi-1 and VRi as its analog output signal (to the corresponding buffer B1) based on the digital value represented by the supplied data signal D1.

The output buffer section 730 includes a plurality of output buffers B1, B2, Bm-1 and Bm that are electrically connected to respective output terminals of the corresponding digital-to-analog converters DAC1, DAC2, . . . , DACm-1 and DACm. Each of the output buffers B1, B2, . . . , Bm-1 and Bm receives a first power voltage VDD1 and a first ground voltage VSS1 as first power-providing voltages, and, for example, in the case of the output buffer B1, each buffers and outputs a corresponding analog data voltage corresponding to the gamma-corrected voltage output by the corresponding digital-analog converter DAC1. Here, a first capacitor C1 and a second capacitor C2 are formed by the conductive pattern 240 so as to be serially connected to each other to form a transient-bypass capacitance C_{cap} between the first power voltage VDD1 and the first ground voltage VSS1. For example, the bypass capacitor charges in between switchings of the digital data signal D1 so as to store an energy component for use by the output buffer B1 at the time that the DAC1 output switches, so that the operation of the output buffer B1 may be stabilized and a ripple component or ringing component of the output signal may be reduced and removed and so that a corresponding transient does not reflect back through the power lines to cause noticeable perturbations in other pixel areas that are not undergoing intentional switching of intensity.

Consequently, a data signal output along each source wiring DL may be stabilized so as to be free of undesired voltage ripples (or so as to have the magnitudes of such ripples substantially reduced), so that display quality may be enhanced.

Hereinafter, substantially the same reference numerals will be used to refer to same or like parts as those described above, and any further repetitive explanation concerning the above elements will be omitted.

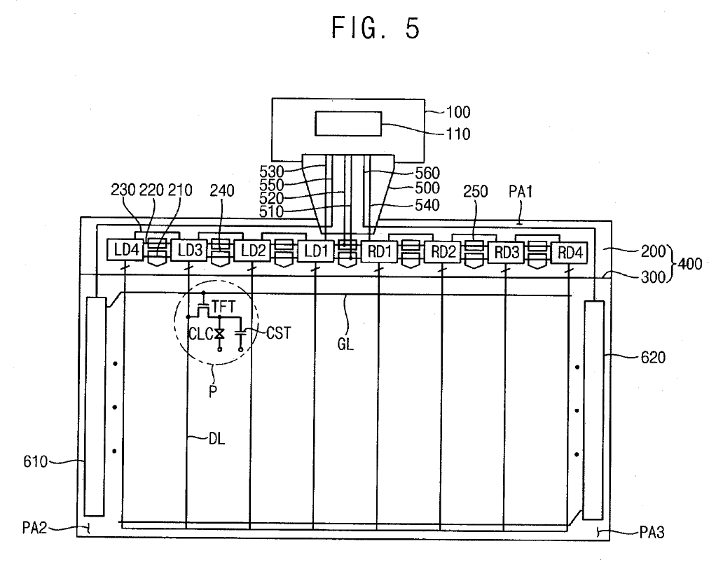

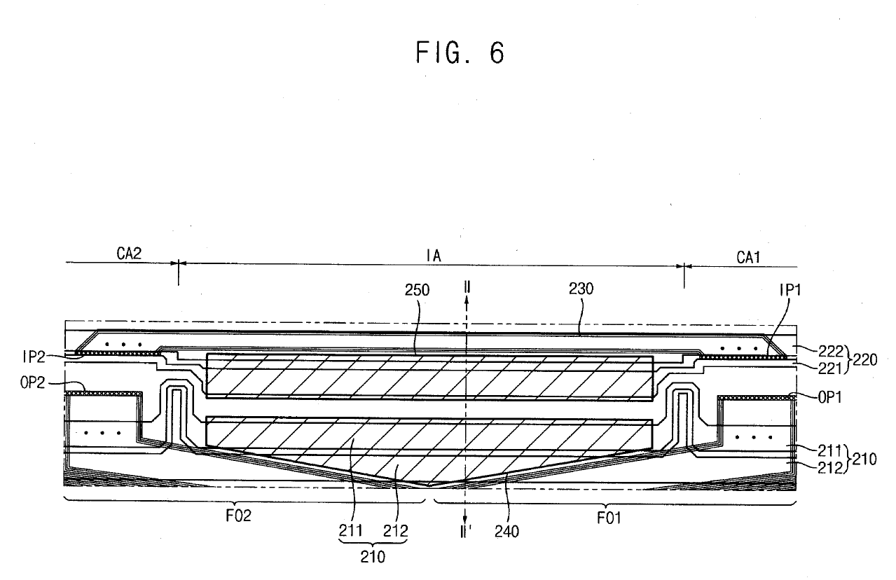

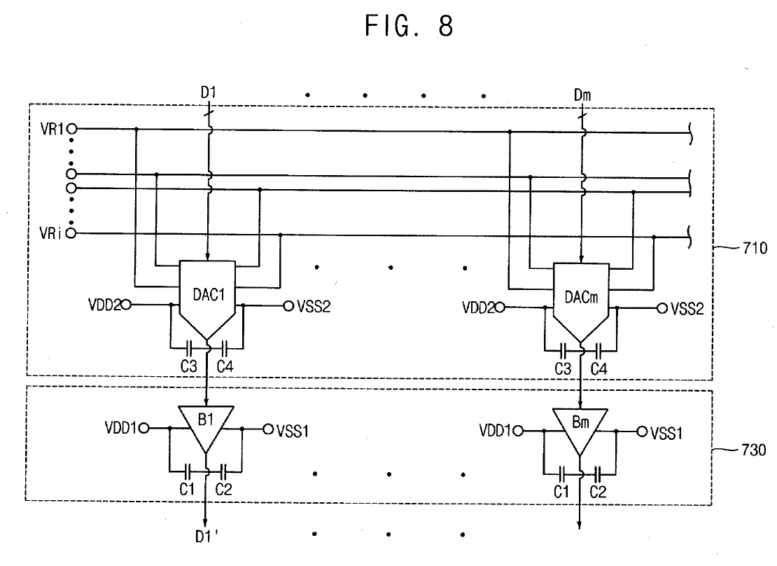

FIG. 5 is a plan view illustrating a display device according to another exemplary embodiment. It will be seen in the schematic of FIG. 8 that a second bypass capacitance is formed by the series connection of C3 and C4 across the power rail defined by the Vdd2 and Vss2 power strips. It is seen from the plan view of FIG. 5 that the addition of conductive pattern 250 is responsible for defining the C3-C4 series circuit. It is seen from the plan view of FIG. 6 that the additional conductive pattern 250 insulatively overlaps with the secondary power strips 221 and 222 as shown.

Referring now to the details of FIG. 5, a display device in accordance with the disclosure includes a PCB 100, a display panel 400 and a flexible PCB 500.

A plurality of source driver chips LD1, . . . , LD4, RD1, RD2, . . . , RD4 is mounted in a first peripheral area PA1 of the display panel 400. The source driver chips output analog type data signals to the source wirings DL.

A first voltage wiring section 210, a second voltage wiring section 220, a connection wiring section 230, a first conductive pattern 240 and a second conductive pattern 250 are formed between the source driver chips. For example, the first voltage wiring section 210 commonly transfers a first power voltage VDD1 and a first ground voltage VSS1 to the source driver chips, and the second voltage wiring section 220 commonly transfers a second power voltage VDD2 and a second ground voltage VSS2 to the source driver-chips. The connection wiring section 230 transfers a digital type data signal and a gamma signal to the source driver chips adjacent to each other.

The first conductive pattern 240 is formed in the first voltage wiring section 210 to define a first bypass capacitor. The first power voltage VDD1 and the first ground voltage VSS1 may be stabilized by transient suppression provided by the first bypass capacitance (C1-C2).

The second conductive pattern 250 is formed in the second voltage wiring section 220 to define a second bypass capacitance. The second power voltage VDD2 and the second ground voltage VSS2 may be stabilized by transient suppression provided by the second bypass capacitance (C3-C4).

Therefore, the first driving voltages VDD1 and VSS1 and the second driving voltages VDD2 and VSS2, which drive each of the source driver chips, may be stabilized, so that a plurality of data signals as output from the source driver chips may be stabilized.

FIG. 6 is an enlarged plan view illustrating a portion of a display substrate in FIG. 5.

Referring to FIGS. 5 and 6, the first voltage wiring section 210, the second voltage wiring section 220, a connection wiring section 230, a first conductive pattern 240 and a second conductive pattern 250 are formed in the intermediate area IA of the display substrate.

A first portion of the first voltage wiring section 210 is overlapped with the first and second fan-out sections FO1 and FO2, and a second portion of the first voltage wiring section 210 is overlapped with the first conductive pattern 240. That is, the first conductive pattern 240 is formed in the intermediate area IA so as not to substantially overlap with the first and second fan-out sections FO1 and FO2.

The first voltage wiring section 210 includes a first power wiring 211 and a first ground-supplying conductor 212. An overlap area between the first conductive pattern 240 and the first power wiring 211 is greater than an overlap area between the first conductive pattern 240 and the first ground-supplying conductor 212.

A first portion of the second voltage wiring section 220 is overlapped with the connection wiring section 230, and a second portion of the second voltage wiring section 220 is overlapped with the second conductive pattern 250. That is, the second conductive pattern 250 is formed in the intermediate area IA so as not to overlap with the connection wiring section 230.

The second voltage wiring section 220 includes a second power wiring 221 and a second ground-supplying conductor 222. An overlap area between the second conductive pattern 250 and the second power wiring 221 is greater than an overlap area between the second conductive pattern 250 and the second ground-supplying supplying conductor 222.

Consequently, a first capacitor C1 and a second capacitor C2 are formed between the first power wiring 211 and the first ground-supplying conductor 212, so that the first power voltage VDD1 and the first ground voltage VSS1 that are transferred to the first power wiring section 210 may be stabilized. Furthermore, a third capacitor C3 and a fourth capacitor C4 are formed between the second power wiring 221 and the second ground-supplying conductor 222 by the second conductive pattern 250, so that the second power voltage VDD2 and the second ground voltage VSS2 that are transferred to the second voltage wiring section 220 may be stabilized.

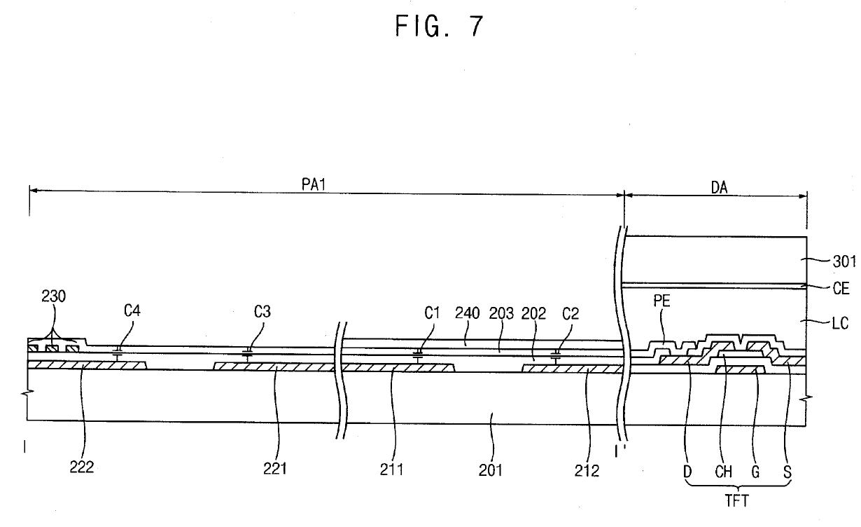

FIG. 7 is a cross-sectional view taken along the line II-II′ in FIG. 6.

Referring to FIGS. 6 and 7, a first power wiring 211 as the first conductive layer, a first ground-supplying conductor 212, a second power wiring 221 and a second ground-supplying conductor 222 are formed in the first peripheral area PA1. The gate insulation layer 202 is formed on the first power wiring 211, the first ground-supplying conductor 212, the second power wiring 221 and the second ground-supplying conductor 222.

The connection wiring section 230, the first fan-out section FO1 and the second fan-out section FO2 as a second conductive layer are formed on the gate insulation layer 202. The passivation layer 203 is formed on the second conductive layer. The first conductive pattern 240 and the second conductive pattern 250 as a third conductive layer are formed on the passivation layer 203. The first conductive pattern 240 is overlapped with the first power wiring 240 and the first ground pattern 212, and the second conductive pattern 250 is overlapped with the second power wiring 221 and the second ground-supplying conductor 222.

Accordingly, the first and second capacitors C1 and C2 are defined between the first power wiring 211 and the first ground-supplying conductor 212. Furthermore, the third and fourth capacitors C3 and C4 are defined between the second power wiring 221 and the second ground-supplying conductor 222. The third and fourth capacitors C3 and C4 are serially connected to each other, so that a capacitance Ccap that is defined the above Expression 1 is formed.

FIG. 8 is an equivalent circuit diagram illustrating a source driving circuit in FIG. 5.

Referring to FIGS. 5 and 8, each of the digital-analog converters DAC1, DAC2, . . . , DACm-1 and DACm receives a second power voltage VDD2 and a second ground voltage VSS2 as second driving voltages, and, for example, in the case of the digital-analog converter DAC1, receives a data signal D1 and a plurality of gamma voltages VR1, VR2, . . . , VRi-1 and VRi through the connection wiring section 230. Each of the digital-analog converters DAC1, DAC2, . . . , DACm-1 and DACm includes a resistor string (resistor ladder), respectively. The second power voltage VDD2 and the second ground voltage VSS2 are used as a reference voltage of the resistor string. The digital-analog converter DAC1 subdivides a single gamma-corrected voltage inputted from an external device into a plurality of gamma-correcting levels corresponding to a total gradation using the resistor string as a means for generating the different voltage levels, and outputs one of the data voltage levels corresponding to the digital data signal (Dm) inputted from an external device.

Here, the third and fourth capacitors C3 and C4 are serially connected to each other between the second power voltage VDD2 and the second ground voltage VSS2 as a driving voltage of the digital-analog converter DAC1, so that the second power voltage VDD2 and the second ground voltage VSS2 are locally maintained as substantially constant voltages by the third and fourth capacitors C3 and C4. Therefore, a ripple component of a switched output signal outputted from the digital-analog converter DAC1 may be reduced and removed.

The output signal of the digital-analog converter DAC1, from which the ripple component is removed, is inputted to the output buffer B1. First driving voltages, that is, the first power voltage VDD1 and the first ground voltage VSS1 that are applied to the output buffer B1, may be stabilized by the first and second capacitors C1 and C2. Consequently, a noise component of the data signal D1′, . . . , Dm′, that is an output signal of the source driver chip may be removed, so that display quality may be enhanced.

According to the present disclosure therefore, in a chip-on-glass (COG) structure or another such structure where integrated circuits are bonded or fused to a display substrate, and in which a source driver chip that mounts directly on the substrate outputs a data signal to a source wiring of the display panel, one or more bypass capacitances are integrally formed with the use of insulatively overlapping conductive patterns for thereby stabilizing the output signals of the source driver chips. The integral bypass capacitances may be monolithically formed on the display panel so as to provide reliable mass production of the same, and so that a noise component of the data signal may be removed. Therefore, a driving signal of the display device may be stabilized, so that display quality may be enhanced.

Although exemplary embodiments have been described, it is understood that the present disclosure of invention should not be limited to the exemplary embodiments and that various changes and modifications can be made by one ordinary skilled in the art while remaining within the spirit and scope of the present disclosure.

What is claimed is:

1. A display substrate structured to have one or more integrated circuits (ICs) bonded thereto for outputting line driving signals onto integral signal-carrying lines of the substrate, the substrate comprising:
an output pads section structured for being electrically connected to a plurality of output terminals of a corresponding one of the ICs;
a fan-out section electrically connecting the output pads section to a subset of the integral signal-carrying lines of the substrate;
a first power wiring section extending along the substrate for propagating a first set of power voltages to at least one of the ICs by way of corresponding first voltage-supplying conductors; and
a first conductive pattern overlapping with the first power wiring section to thereby define a first bypass capacitance that shunts between at least two of the first voltage-supplying conductors.

2. The display substrate of claim 1, wherein the first power wiring section comprises:
a first voltage-supplying conductor structured to receive a first power voltage from an external source and to propagate the first power voltage to the at least one of the ICs; and
a first ground-supplying conductor structured to extend substantially parallel to the first voltage-supplying conductor and to receive a first ground voltage from an external source and to propagate the first power voltage to the at least one of the ICs.

3. The display substrate of claim 2, wherein a first portion of the first power wiring section is overlapped with the fan-out section but not with the first conductive pattern.

4. The display substrate of claim 3, wherein a second portion of the first power wiring section is overlapped with the first conductive pattern.

5. The display substrate of claim 4, wherein an overlap area between the first conductive pattern and a first of the at least two voltage-supplying conductors is greater than an overlap area between the first conductive pattern and a second of the at least two voltage-supplying conductors.

6. The display substrate of claim 1, further comprising:
an input pads section for electrically connecting to a corresponding plurality input terminals of the IC's; and
a connection wiring section for electrically connecting the input pads sections of adjacent IC's to each other.

7. The display substrate of claim 6, further comprising:
a second power wiring section extending substantially parallel to the first power wiring section, the second power wiring section applying second driving voltages to the IC's; and
a second conductive pattern being overlapped with the second power wiring section.

8. The display substrate of claim 7, wherein the second power wiring section comprises:
a second voltage-supplying conductor receiving a second power voltage; and
a second ground-supplying conductor that is substantially parallel to the second ground-supplying conductor, wherein the second ground-supplying conductor receives a second ground voltage.

9. The display substrate of claim 8, wherein a first portion of the second power wiring section is formed in an intermediate area between adjacent IC's and is overlapped with the connection wiring section.

10. The display substrate of claim 9, wherein a second portion of the second power wiring section is formed in the intermediate area and is overlapped with the second conductive pattern.

11. The display substrate of claim 8, wherein an overlap area between the second conductive pattern and the second ground-supplying conductor is greater than an overlap area between the second conductive pattern and the second ground-supplying conductor.

12. The display substrate of claim 11, wherein the first and second power wiring sections are formed from a first conductive layer, and the first conductive layer is further used to form gate wirings,
the fan out section and the connection wiring section are formed from a second conductive layer, and the second conductive layer is further used to form source wirings, and
the first and second conductive patterns are formed from a third conductive layer, and the third conductive layer is further used to form one or more pixel electrodes that are electrically insulated from the first conductive layer.

13. A display device comprising:
a gate-lines driving section for outputting a plurality of gate-driving signals to a plurality of gate wirings provided in a display area of the display device;
a plurality of source-lines driver chips for outputting a plurality of data signals to a plurality of source wirings that cross the gate wirings;
a first power wiring section formed in a peripheral area of the display device and having the source-lines driver chips mounted therein, the first power wiring section propagating first power-delivering voltages to the source-lines driver chips;
is a second power wiring section formed in the peripheral area, the second power wiring section propagating second power-delivering voltages to the source-lines driver chips; and
a first conductive pattern overlapping at least a first portion the first power wiring section in an intermediate area between adjacent ones of the driver chips, the first conductive pattern providing a capacitive shunt path for AC voltage signals appearing in the first power wiring section and thereby stabilizing voltage levels in the overlapped portion the first power wiring section.

14. The display device of claim 13, wherein the first power wiring section comprises a first power wiring that receives a first power voltage, and a first ground-supplying conductor that receives a first ground voltage,
wherein the second power wiring section comprises a second power wiring that receives a second power voltage, and a second ground-supplying conductor that receives a second ground voltage.

15. The display device of claim 14, further comprising:
a fan-out section electrically connecting the source driver chips to the source wirings; and
a connection wiring section transferring a data signal to the source driver chips adjacent to each other by a cascade method.

16. The display device of claim 15, wherein the first power wiring section formed in the intermediate area is partially overlapped with the fan-out section, and the first power wiring section is partially overlapped with the first conductive pattern.

17. The display device of claim 16, wherein an overlap area between the first conductive pattern and the first ground voltage wiring is greater than an overlap area between the first conductive pattern and the first voltage-supplying conductor.

18. The display device of claim 15, further comprising:
a second conductive pattern overlapping at least a portion of the second power wiring section formed in an intermediate area to thereby provide a capacitive shunt path for AC voltage signals appearing in the second power wiring section and to thereby stabilize voltage levels in the overlapped portion the second power wiring section.

19. The display device of claim 18, wherein the second power wiring section formed in the intermediate area is partially overlapped with the connection wiring section, and the second power wiring section is partially overlapped with the second conductive pattern.

20. The display device of claim 19, wherein an overlap area between the second conductive pattern and the second voltage-supplying conductor is greater than an overlap area between the second conductive pattern and the second ground pattern.

21. A method of manufacturing one or more bypass capacitors integrally on a display substrate having a corresponding one or more power wiring sections disposed thereon for propagating power-delivering voltages to integrated circuits that are to be further mounted to the display substrate, the method comprising:
disposing a dielectric layer over at least a first of voltage propagating conductors extending in the one or more power wiring sections; and
disposing a conductive pattern on the dielectric layer so that the conductive pattern insulatively overlaps the at least first of voltage propagating conductors, wherein the conductive pattern further overlaps at least a second of the voltage propagating conductors extending in the one or more power wiring sections so as to thereby define a capacitive shunt path for AC voltage signals appearing between the at least first and second of the voltage propagating conductors.
